(19) United States
(12) Patent Application Publication
(10) Pub. No.: US 2018/0009495 A1
(43) Pub. Date: Jan. 11, 2018

(54) MOTORCYCLE CHILD SAFETY GRIPS

(71) Applicant: David L. Allred, Valparaiso, IN (US)

(72) Inventor: David L. Allred, Valparaiso, IN (US)

(21) Appl. No.: 15/643,886

(22) Filed: Jul. 7, 2017

Related U.S. Application Data
(60) Provisional application No. 62/359,787, filed on Jul. 8, 2016.

(51) Int. Cl. B62J 1/28

(52) U.S. Cl. CPC B62J 1/28

(57) ABSTRACT

The present invention may include grip handles which may be held by a tandem rider while riding on a motorcycle. The grip handles may be secured to a series of interconnected pipes which are attached to the motorcycle. For example, the grip handles may be secured to corresponding grip pipes. Further, the grip pipes may be adjustably connected to corresponding bottom pipes. Further, the bottom pipes may be adjustably connected to a main pipe, which may be secured to the motorcycle by an adapter. The series of interconnected pipes may be adjustable to accommodate a tandem rider of any size, and/or to accommodate any preference of the tandem rider.

### FIELD OF THE INVENTION

The present invention generally relates to vehicular systems, and more particularly to safety grips for use by a child sitting behind the operator of a motorcycle.

### BACKGROUND

Motorcycles have existed in various forms since about the 1860s and by the 1880s dozens of designs had emerged for commercial distribution in countries like Germany, England, and the United States of America. By the post-World War I era, motorcycles had been vastly improved and made available in over 67 countries around the world.

Motorcycles have provided a smaller, cheaper alternative to automobiles, enabling an operator to commute longer distances using significantly less fuel. Motorcycles may be capable of accommodating a secondary rider, often called a tandem rider, who sits behind the operator of the motorcycle. Unlike the driver, the tandem rider does not have any ability to control the vehicle. Tandem riders may fall off of the motorcycle during an accident and/or during normal operation, which may cause injury to the tandem rider or others in the vicinity.

In order to prevent injury to the tandem rider and others, efforts continue to develop means for providing the tandem rider with additional stability, balance, and confidence while riding on a motorcycle.

### SUMMARY

An embodiment is proposed for a tandem rider stability apparatus. The apparatus may include an adapter coupled to a motorcycle. The apparatus may further include a main pipe including with at least a first set of slots. The adapter may extend through the first set of slots. The apparatus may further include at least a first bottom pipe. A first end of the first bottom pipe may be coupled at a first end of the main pipe. The apparatus may further include at least a first grip pipe. A first end of the first grip pipe may be coupled at a second end of the first bottom pipe.

### BRIEF DESCRIPTION OF THE DRAWINGS

Various aspects and advantages of the invention will become apparent upon review of the following detailed description and upon reference to the drawings in which:

FIG. 1 illustrates an isometric view of a tandem rider stability apparatus, according to an embodiment of the present invention;

FIG. 2 illustrates an exploded view of a tandem rider stability apparatus, according to another embodiment of the present invention;

FIG. 3 illustrates an expanded view of one or more components illustrated in FIG. 2;

FIG. 4 illustrates an expanded view of one or more components illustrated in FIG. 2;

FIG. 5 illustrates an expanded view of one or more components illustrated in FIG. 2;

FIG. 6 illustrates an expanded view of one or more components illustrated in FIG. 2.

### DETAILED DESCRIPTION

Motorcycle Child Safety Grips are an invention to help a person ride on a motorcycle with the added comfort, safety and mental security of having extended handles to hold that are securely fastened to the motorcycle. They will be extendable and adjustable so as to work for all child sizes (as long as the child is able to sit up and grip for an extended amount of time) as well teenagers, handicapped individuals, and adults. The expected primary use may be children ages 2 years and up. Though the parts are relatively simple, they allow for multiple functions. I will add descriptions of each following the use and function as a whole.

The Motorcycle Child Safety Grips are comprised of several small hollow pipes, with corresponding holes to allow for an extension ability. They will fasten to the back of the bike using the same bolt that fastens the rear seat and will extend up at different heights to allow fit for all rear seat heights. There will be a wedge piece and screws to fasten it in creating a secure hold that will not wobble or shift while in use. There will also be small wires with hooks to allow a firmer hold without having to permanently alter the bike at all. At the top of the adapter there will be a pipe (e.g., about 13″ long and about 1″ thick) that has a series of holes for extension and rotation allowing the grips to extend from 0″ to as much as 19″ or possibly more. The extra holes also allow for pointing the grips at different angles and rotation of the grips over 180 degrees for possible storage ends and to keep out of the way of adult riders who may prefer riding without the grips. Because the pipes will attach with pushable pins (e.g., detents) they will also be easily removed or attached as desired. Once attached the center pipe is not meant or needed to be removed though it easily could be if needed simply by removing the bolt that connects it to the base (the same one the connects the rear seat). From the center pipe a pipe approximately 2′ long with a bend in it (about 90 degrees) will extend from both sides, connected by pins (similar to those on a walking cane to extend height) that can be pushed in and slid to different holes to adapt the right width of the rider. On the forward facing bend the bar will stick out moving along the bottom of the rider toward the riders front with several additional holes to adapt to different size riders and different arm lengths. It should allow a reach from the rear of the rider (e.g. between about 1′ and about 2′). This pipe will have 2 sets of holes allowing the next set of pipes to either extend up or up and in depending on the desired location of the rider. From this pipe there will be another pipe about 20″ long and again bent but instead of continuing forward it will bend up placing grippable handles in front of the rider. This piece will have easily grippable handles made of rubber or plastic at the end to aid the grip and the help reduce heat while in or out of use. The last set of medal pipes will be held in place by the same type of pins as the other pieces. To the rider it is secure and has several different pipes involved, but to a passerby it would just look like 2 grips extending up from the front of the passenger to allow for a comfortable ride, a safer ride, and more relaxed feelings for both the rider and the passenger.

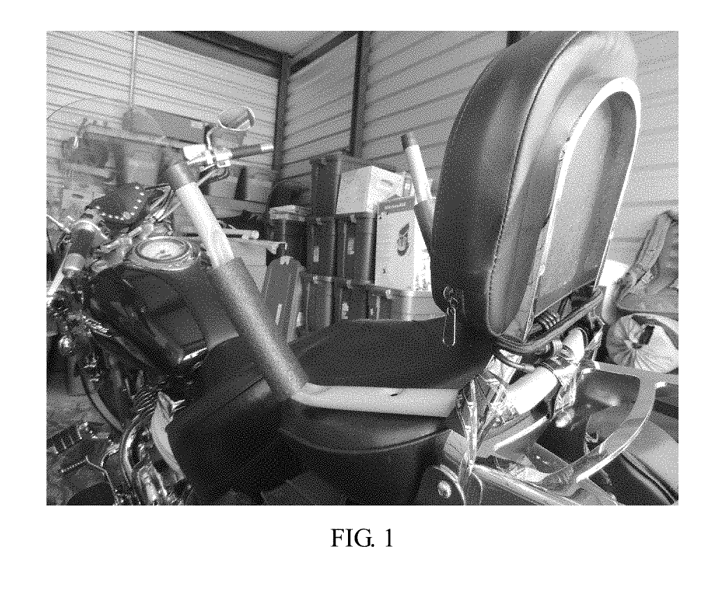

A prototype of the present invention is exemplified in FIG. 1, which illustrates a bar assembly connected to the rear seat of a motorcycle. The bar assembly extends forwardly of the rear seat-back, then upwardly to provide hand grips for the tandem rider (e.g., a child).

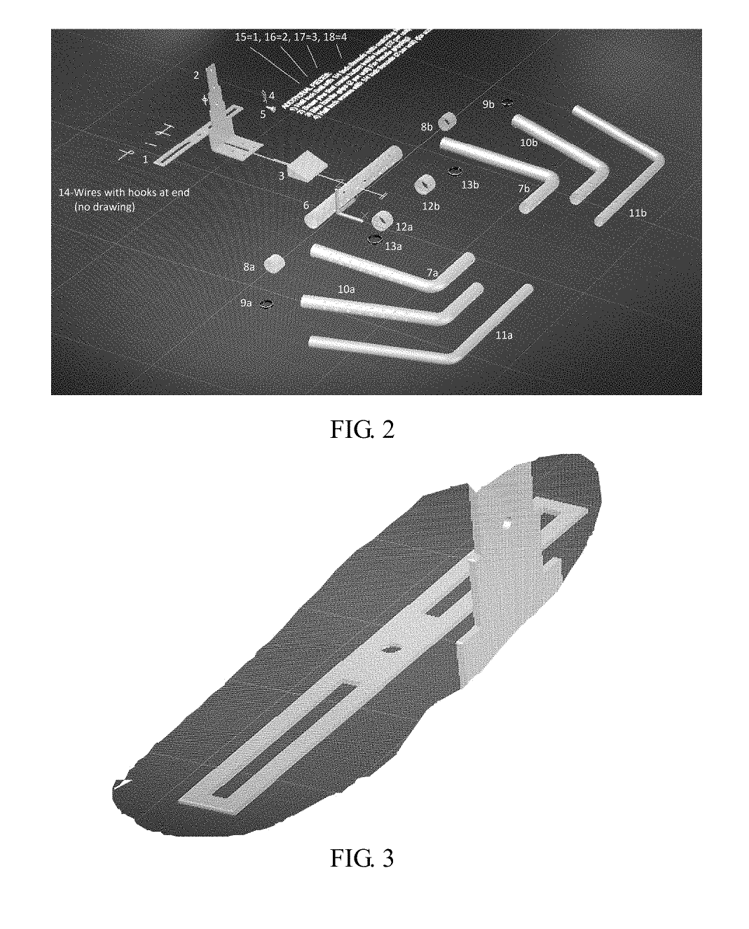

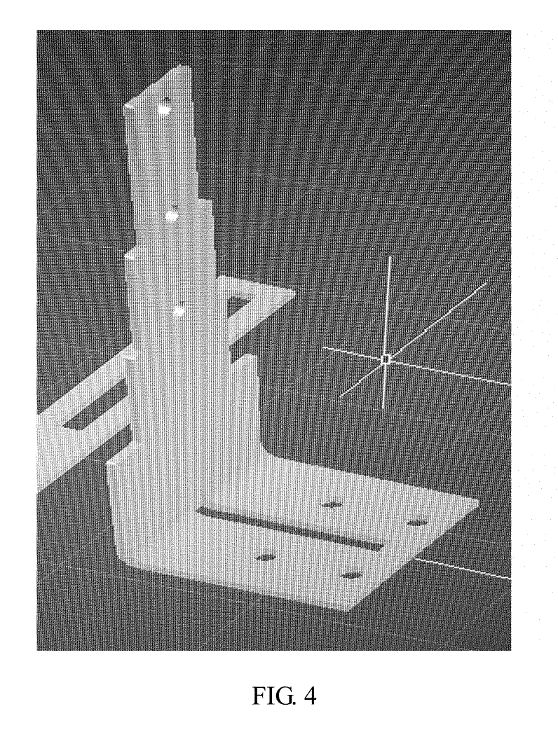

As illustrated in FIGS. 2 and 3, an older bike seat attachment bar 1 may be provided for enabling attachment to older types of seats, in various widths. The older bike seat attachment bar 1 may attach with two screws under the seats instead of one screw behind the seat. It can fit different type seats because the bar will have two solid long slots instead of individual small holes that can be shifted and be placed in the right position to fit the two connector screws. Then the middle hole can connect to an adapter (e.g., adapter 2 of FIG. 4) using a common nut, washer, and bolt combination. If the seat uses a single bolt in the back of this piece the nut, washer, bolt combination will not be needed.

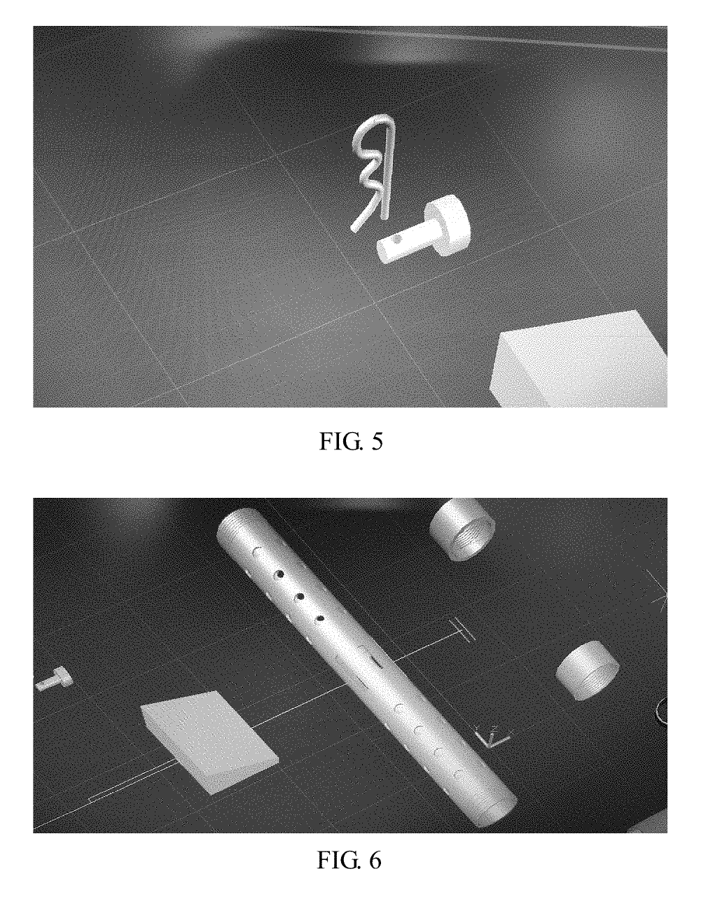

Adapter 2, as exemplified in FIGS. 2 and 4, may be a piece of strong metal (e.g., steel) that connects the bike to a main pipe (e.g., main pipe 6) of the present invention. Adapter 2 may be shaped with a flat section on the bottom that has an open rectangular slot for connecting it to the bike. Adapter 2 may be designed to be able to be place with the upper facing section to the front or back depending on the type of seat or extras the bike may already have attached. This allows the part to be placed in various positions and to be slid back and forth to the desired fit. There may be 4 other holes in the bottom section for attachment of a wedge (e.g., wedge 3 of FIG. 2) to enable the wedge to be held securely in place whether the rear section of a bike has a circular shape or a flat surface. These holes may also be used to fasten wire hooks (not shown) to the bike. Adapter 2 may have sections that rise up, such that the sections gets smaller in intervals. The sections that get smaller enable adapter 2 to fit into different corresponding holes of a main pipe (e.g., main pipe 6 of FIGS. 2 and 6), so that the main pipe can be held up at different heights depending on the thickness of the bike seat in place. At the top of each section may be a pin hole for securing the main pipe in place using a traditional bolt and pin (e.g., bolt 4 and pin 5 of FIG. 5). This adapter should be versatile enough with the additional parts to be adapted and used with almost every bike that has a back seat for a rear rider.

Wedge 3, as illustrated in FIGS. 2 and 6, may be a plastic wedge that can be cut and slid in at different angles under the adapter 2 after it is secured to wedge it in place and hold it so that adapter 2 does not move, shift, or dislodge during riding. After wedge 3 is wedged into place it can be connected to adapter 2 using the 4 holes in the bottom of adapter 2 (e.g., using screws 18). After it is secured into place the edges of the wedge can be trimmed to create better eye appeal if desired. Then the wedge can be further secured by the wire hooks (not shown).

Pin 4 and bolt 5, as illustrated in FIGS. 2 and 5, may be used to secure main pipe 6 to adapter 2 as described herein. Main pipe 6 may be slid over adapter 2 in the desired height for the type of bike and seat, then bolt 5 may be inserted through a corresponding hole of adapter 2 immediately above main pipe 6, to secure main pipe 6 in place. Pin 4 may be inserted through an end of bolt 5 to secure bolt 5 within the hole of adapter 6. Pin 4 may have a particular geometry to enable pin 4 to be retaining on the end of bolt 5.

Main pipe 6, may be the largest in diameter of all the pipes and may have several functions and adaptations for the present invention. In a center of main pipe 6 there may be one or more slits cut, with a corresponding slit cut of the exact same size on the opposite side. This may be where adapter 2 slides through thus making it impossible to fall off as long as the pin 4 and bolt 5 are in place above main bar 6. Further, on both sides of the slit there may be several holes where one or more bottom pipes (e.g., bottom pipes 7a, 7b, 10a, and/or 10b) can connect (e.g., using one or more cane pins 16). This allows the bottom pipes to be held in place securely but also allows them to be adjusted in or out with ease allowing the present invention to adjust to almost any size (e.g., accommodating differently sized tandem riders). Bottom pipes may be adjustable laterally with respect to the main pipe.

A similar set of holes are found in the bottom pipes thus enabling rotation of between about 0 and about 180 degrees where they can be securely held behind the seat allowing for a duel function where they could be used as sides to strap cargo. Accordingly, if main pipe 6 were removed, rotated, and reinstalled on adapter 2 to a different slit (e.g., a larger slit), main pipe 6 may sit higher or lower to accommodate different heights. The slits in main pipe 6 may be placed at intervals around the circumference of the pipe (e.g., at about 60 degree intervals) thus enabling many variations of attachment for added comfort, safety, and usability. At the end of each side of main pipe 6 there may be threads to enable a screwing piece (e.g., screwing piece 12a, and/or 12b) with a small plastic center to be screwed into place securely attaching main pipe 6 to the bottom pipes. This may reduce rattling, create a stronger hold, and/or may be an added measure of safety no matter how the bottom pipes are adjusted.

Bottom pipes 7a and 7b, as illustrated in FIG. 2, may be between about 6″ and about 45″ long (e.g., about 2′ long) with an elbow at some point along its length (e.g., a 90 degree bend positioned at a distance slightly less then half its length). On the shorter end there may be 2 holes in each bottom pipe where one or more cane pins (e.g., cane pins 16) connect enabling connection to main pipe 6 (e.g., a dual connection to reduce rotational shifting). Bottom pipes 7a, 7b may be capable of sliding in and out and may attach to one or more holes or sets of holes of the main pipe 6 to accommodate many different sizes and angles, though a normal horizontal angle will probably work best because it may allow bottom pipes 7a, 7b to extend along a desired height for the tandem rider. On the longer end of the bottom pipes 7a, 7b there may be 2 sets of holes, a first set extending incrementally along a side of each pipe, and a second set extending incrementally at an offset to the first set (e.g., offset about 45 degrees higher). This may allow for connection of one or more grip pipes (e.g., grip pipes 11a and 11b of FIG. 2) to be adjusted to either a straight up direction where the holder would grip reaching in front and at an up, or in an inward direction where the rider could hold right out in front of them. Where the first and second sets of holes include several holes (e.g., about an inch apart) grip pipes may be capable of easy adjustment to various arm lengths and body sizes. For example, grip pipes may be adjustable forwardly and/or rearwardly with respect to the tandem rider, the vehicle, or both. In another example, grip pipes may be positioned ergonomically for being held by a tandem rider of the vehicle. At the end of bottom pipes 7a, 7b there may be threads to enable each bottom pipe to be securely attached using a threaded piece (e.g., threaded piece 8a, or 8b) and a piece of inside plastic (e.g., inside plastic 9a, or 9b) allowing a stronger hold, eliminating rattling, and creating an extra safety measure. This piece may slide inside of the main pipe 6 and thus may be slightly smaller in diameter.

Threaded pieces 8a, 8b, as illustrated in FIG. 2, may be threaded on the inside only on 1 side and may be thicker on the other inside end. This may allow for a corresponding piece of inside plastic 9a, 9b to be inserted inside, such that when screwed to main pipe 6 the threaded piece and corresponding piece of inside plastic may create a tight grip onto bottom pipes (e.g., bottom pipes 7a, 7b, 10a, or 10b) while securely attaching them to main pipe 6. In the present invention, the combination of the threaded piece with the piece of inside plastic may reduce rattling, create a secure grip, and/or add a safety measure that make the possibility of the pieces detaching while riding extremely lower. It may also create a look that makes the two separate parts look more like 1 simple part.

The pieces of inside plastic 9a, 9b may be hard plastic and they may not be complete rings (e.g., each may have a slit in them where they can be squeezed and tightened upon). The pieces of inside plastic 9a, 9b may have slanted edges so that when tightened they slide between the two connecting pipes (e.g., between main pipe 6 and at least one of the bottom pipes) creating a wedge that is then screwed into place. Alternatively, the pieces of inside plastic 9a, 9b may enable securement of grip pipes (e.g., grip pipes 11a and 11b of FIG. 2). In any embodiment, the pieces of inside plastic 9a, 9b may, when tightened, connect the pipes tightly, creating grip, reducing rattle, and adding security.

Bottom pipes 10a, 10b, as illustrated in FIG. 2, may be similar to bottom pipes 7a, 7b, but may represent angled bottom pipes (e.g., with an elbow less than or greater than the 90 degree bend of bottom pipes 7a, 7b). The smaller or greater bend may accommodate different sized tandem riders (e.g., adults). In another embodiment, the angle of the bend may be adjustable, such that any angle may be possible in a single set of bottom pipes.

Grip pipes 11a, 11b, as illustrated in FIG. 2, may be the smallest in diameter and may be sized to slide into the bottom pipes (e.g., any of bottom pipes 7a, 7b, 10a, and/or 10b). Alternatively, grip pipes 11a, 11b may be larger enough to slide over the bottom pipes. Grip pipes 11a, 11b may be between about 6″ and about 45″ (e.g., about 2 feet long), each with a bend at a position along their lengths. For example, the bend may be at about the length, and the bend may greater than 90 degrees. Thus, grip pipes 11a, 11b may extend out and in front of the tandem rider instead of straight up adding ease of grip and comfort. It also puts the edges farther from the rear rider aiding in protecting the face in the event of a sudden stop or collision. They are designed to be a sturdy but thinner or lighter metal (e.g., aluminum) so that they support body weight but in the event of a motorcycle accident they will bend and break before crushing or stabbing. At the bottom end of each grip pipe 11a, 11b there may be two cane pins 16 where they securely attach to corresponding bottom pipes (e.g., bottom pipes 7a, 7b, 10a, and/or 10b) but are also adjustable for comfort and ease of use to accommodate various sized tandem riders (e.g., hip size and/or arm length). Each grip pipe 11a, 11b may be solid or hollow, and if hollow may have capped ends for safety (e.g., as exemplified in FIG. 7). Alternatively, ends may be covered by one or more grip handles 17. Grip pipes 11a, 11b may be secured by threaded pieces 8a, 8b, pieces of inside plastic 9a, 9b, and/or cane pins 16 for safety and to reduce rattle and vibration. They can be extended either at arms length apart or closer together depending on the comfort and desire of the tandem rider due to the second set of holes in bottom pipes (e.g., bottom pipes 7a, 7b, 10a, and/or 10b). The grip handles 17 may attach to corresponding top ends of each grip pipe 11a, 11b.

Screwing pieces 12a, 12b, may be similar to threaded pieces 8a, 8b. Alternatively, screwing pieces 12a, 12b may be differently sized in order to fit differently size pipes. Screwing pieces 12a, 12b may attach in a similar way and may complete a similar function as threaded pieces 8a, 8b. Further, rings 13a, 13b, may be similar in size, and function to the pieces of inside plastic 9a and 9b. Alternatively, rings 13a, 13b may be differently sized (e.g., corresponding to the size of screwing pieces 12a, 12b). Rings 13a, 13b may attach in a similar way and may complete a similar function as the pieces of inside plastic 9a and 9b.

Wire hooks 14 (not shown), may hook under the back fender on each side of the motorcycle and may go up through bottom rear holes of adapter 2. In another example, wire hooks 14 may twist together to tighten after wedge 3 is in place to securely hold the adapter 2 to the motorcycle in the front and rear for safety and stability. Wired hooks 14 may also be secured with twist ties in the same fashion but without twisting to secure.

A nut, a bolt, and a washer (e.g., not shown, but referenced in FIG. 2 by 15), may be used to attach an embodiment of the present invention to adapter 2. The nut, bolt, and washer may be standard items that can be purchased at any retail hardware store.

Cane pins 16, may be brass, and further may be universal enough that 1 size will fit all parts designated in the present invention. They are simply a small medal button fastened to a medal wire and bent creating a spring to hold them in place (e.g., within an interior of corresponding pipes). For example, each set of pipes forming the present invention may require 8 cane pins.

Grip handles 17, may be made of rubber and secured simply by being tightly fitted onto corresponding grip pipes. For example, grip handles 17 may have to fit securely onto grip pipes 11a, 11b. They should help to keep the rider from burns caused by the pipes heating up in the sun and provide better grip for the rider and better comfort.

Other aspects and embodiments of the present invention will be apparent to those skilled in the art from consideration of the specification and practice of the invention disclosed herein. It is intended, therefore, that the specification and illustrated embodiments be considered as examples only, with a true scope and spirit of the invention being indicated by the following claims.

1. A tandem rider stability apparatus capable of mounting to a vehicle which may receive a tandem rider, the tandem rider stability apparatus comprising:
an adapter capable of mounting to the vehicle; and
one or more pipes coupled to the adapter, the one or more pipes extending from the adapter to be grippable by the tandem rider.

2. The tandem rider stability apparatus of claim 1, wherein the adapter is mounted to a seat back of the vehicle.

3. The tandem rider stability apparatus of claim 1, wherein the adapter is mounted to a seat bottom of the vehicle.

4. The tandem rider stability apparatus of claim 1, wherein the one or more pipes includes a main pipe mounted to the adapter, the main pipe being height adjustable with respect to the adapter.

5. The tandem rider stability apparatus of claim 4, wherein the one or more pipes includes a first bottom pipe mounted to the main pipe, the first bottom pipe being adjustable laterally with respect to the main pipe.

6. The tandem rider stability apparatus of claim 5, wherein the one or more pipes includes a first grip pipe mounted to the first bottom pipe, the first grip pipe being adjustable forwardly and rearwardly with respect to the first bottom pipe.

7. The tandem rider stability apparatus of claim 5, wherein the one or more pipes includes a second bottom pipe mounted to the main pipe, the second bottom pipe being adjustable laterally with respect to the main pipe.

8. The tandem rider stability apparatus of claim 7, wherein the one or more pipes includes a second grip pipe mounted to the second bottom pipe, the second grip pipe being adjustable forwardly and rearwardly with respect to the second bottom pipe.

9. The tandem rider stability apparatus of claim 4, wherein the one or more pipes includes a first grip pipe coupled to the main pipe, the first grip pipe being adjustable forwardly and rearwardly with respect to the main pipe.

10. The tandem rider stability apparatus of claim 9, wherein the one or more pipes includes a second grip pipe coupled to the main pipe, the first grip pipe being adjustable forwardly and rearwardly with respect to the main pipe.

11. The tandem rider stability apparatus of claim 4, wherein the one or more pipes includes a first bottom pipe mounted to the main pipe, the first bottom pipe being adjustable rotationally with respect to the main pipe.

12. The tandem rider stability apparatus of claim 11, wherein the one or more pipes includes a first grip pipe mounted to the first bottom pipe, the first grip pipe being adjustable rotationally with respect to the first bottom pipe.

13. The tandem rider stability apparatus of claim 11, wherein the one or more pipes includes a second bottom pipe mounted to the main pipe, the second bottom pipe being adjustable rotationally with respect to the main pipe.

14. The tandem rider stability apparatus of claim 13, wherein the one or more pipes includes a second grip pipe mounted to the second bottom pipe, the second grip pipe being adjustable rotationally with respect to the second bottom pipe.

15. The tandem rider stability apparatus of claim 4, wherein the one or more pipes includes a first grip pipe coupled to the main pipe, the first grip pipe being adjustable rotationally with respect to the main pipe.

16. The tandem rider stability apparatus of claim 15, wherein the one or more pipes includes a second grip pipe coupled to the main pipe, the first grip pipe being adjustable rotationally with respect to the main pipe.

17. A tandem rider stability apparatus capable of mounting to a vehicle which may receive a tandem rider, the tandem rider stability apparatus comprising:
an adapter capable of mounting behind a seat of the vehicle; and
one or more pipes coupled to the adapter, the one or more pipes extending from the adapter to a position grippable by the tandem rider.

18. The tandem rider stability apparatus of claim 17, wherein the one or more pipes includes a main pipe mounted to the adapter, the main pipe including one or more slots; and wherein the adapter extends through the one or more slots, and the main pipe is mountable at one or more heights of the adapter.

19. The tandem rider stability apparatus of claim 17, wherein the one or more pipes are adjustable forwardly, rearwardly, laterally, and rotationally with respect to the vehicle to enable ergonomic gripping by the tandem rider.

20. A method of adjusting a tandem rider stability apparatus mounted on a vehicle which may receive a tandem rider, the method comprising:
positioning an adapter on the vehicle;
positioning one or more pipes on the adapter; and
adjusting the one or more pipes with respect to the vehicle, such that the one or more pipes are ergonomically placed for gripping by a tandem rider.
